(19) United States
(12) Patent Application Publication
(10) Pub. No.: US 2025/0225250 A1
(43) Pub. Date: Jul. 10, 2025

(54) MANAGING SECURITY FOR APPLICATION DEPLOYMENT

(71) Applicant: GM Cruise Holdings LLC, San Francisco, CA (US)

(72) Inventors: Nitish Krishna Kaveri Poompatnam Chandrasekaran, Pleasanton, CA (US); Beshoy Girgis, Kansas City, MO (US)

(73) Assignee: GM Cruise Holdings LLC, San Francisco, CA (US)

(21) Appl. No.: 18/404,019

(22) Filed: Jan. 4, 2024

(51) Int. Cl. G06F 21/57; G06F 8/60

(52) U.S. Cl. CPC G06F 21/577; G06F 8/60

(57) ABSTRACT

A company that develops software applications for operating and managing autonomous vehicles has an array of developer teams working on many different projects. In addition, continuous integration and continuous delivery of software applications for the company can involve complex pipelines. A pipeline for an application can include parts, such as, integration testing, building, build testing, deploying, and monitoring the application. Different systems may be tasked to execute a part of the pipeline for the application on a destination (e.g., a particular namespace), and the respective systems may need access and/or permissions to execute the part of the pipeline on the destination. Adhering to the principle of least privilege access, permission(s) for executing the part of the pipeline may be narrowly scoped for the system executing the part, so that the system may have only what the system needs to execute the part of the pipeline, and no more.

### TECHNICAL FIELD

The present disclosure generally relates to cluster infrastructure management and, more specifically, to dynamic permissions management for cloud workloads.

### BACKGROUND

Cluster infrastructure can include hardware and software resources deployed to support systems with high availability, scalability, and performance. Systems can be deployed on the cluster infrastructure, and the cluster infrastructure enables the systems to service requests being made to the systems.

Autonomous vehicles (AVs), also known as self-driving cars, and driverless vehicles, may be vehicles that use multiple sensors to sense the environment and move without human input. Technology in AVs may enable vehicles to drive on roadways and to accurately and quickly perceive the vehicle's environment, including obstacles, signs, and traffic lights. AV technology may utilize geographical information and semantic objects (such as parking spots, lane boundaries, intersections, crosswalks, stop signs, and traffic lights) for facilitating vehicles in making driving decisions. The vehicles can be used to pick-up passengers and drive the passengers to selected locations. The vehicles can also be used to pick-up packages and/or other goods and deliver the packages and/or goods to selected locations.

### BRIEF DESCRIPTION OF THE DRAWINGS

The various advantages and features of the present technology will become apparent by reference to specific implementations illustrated in the appended drawings. A person of ordinary skill in the art will understand that these drawings show only some examples of the present technology and would not limit the scope of the present technology to these examples. Furthermore, the skilled artisan will appreciate the principles of the present technology as described and explained with additional specificity and detail through the use of the accompanying drawings.

Figure (FIG. 1 illustrates an exemplary system that may be used to facilitate operations of one or more AVs, according to some aspects of the disclosed technology.

FIG. 2 illustrates an exemplary system that application developers may use to develop and deploy applications onto remote locations such as specific namespaces, according to some aspects of the disclosed technology.

FIG. 3 illustrates an exemplary sequence diagram illustrating creation of projects and namespaces, according to some aspects of the disclosed technology.

FIG. 4 illustrates an exemplary sequence diagram illustrating generation of API tokens, according to some aspects of the disclosed technology.

FIG. 5 illustrates an exemplary sequence diagram illustrating generation of application programming interface (API) tokens, according to some aspects of the disclosed technology.

FIG. 6 illustrates an exemplary sequence diagram illustrating deployment of an application, according to some aspects of the disclosed technology.

FIG. 7 illustrates an exemplary project, according to some aspects of the disclosed technology.

FIG. 8 illustrates exemplary paths for storing different API tokens, according to some aspects of the disclosed technology.

FIG. 9 is a flow diagram illustrating an exemplary computer-implemented method for managing security in application deployment, according to some aspects of the disclosed technology.

FIG. 10 illustrates an exemplary processor-based system with which some aspects of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details that provide a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

### Overview

A company that develops software applications for operating and managing AVs has an array of developer teams working on many different projects. One developer team may be in charge of developing and deploying an application for processing sensor data on the AVs. One developer team may be in charge of developing and deploying an application for allowing voice calls in the AVs through microphones inside the AV. Another developer team may be in charge of developing a simulation application for testing an AV stack (involving perception, understanding, planning, and controls) in a computer-simulated environment. Another developer team may be in charge of developing the AV stack that is to be deployed on the AVs. Another developer team may be in charge of developing a web application to be used by users wanting to book a ride with an AV. Another developer team may be in charge of processing sensor data gathered by mapping vehicles. Another developer team may be in charge of developing software for embedded systems on the AV fleet. There may be many other developer teams working on other applications.

Some software applications that support operations of an AV fleet can be implemented on and supported by cluster infrastructure. Some software applications that deal with operations of the AVs can be implemented on the AV fleet. Compute hardware on the AV fleet can be managed in a manner similar to cluster infrastructure. Examples of such applications (and platforms) are described with FIG. 1.

Different developer teams may be utilizing or performing actions on shared infrastructure of the company, e.g., multi-tenancy cluster infrastructure, or the AV fleet where different developer teams may need to deploy and monitor the software applications on the AV fleet. Namespaces can be used to segment the shared infrastructure so that resources in the shared infrastructure can be segregated and assigned to different developer teams. A developer team working on a project can create a namespace for the project, and get permissions scoped to manipulate the namespace (and not other namespaces that are not assigned to the developer team).

Lifecycle of software applications involves many parts or steps from developer teams writing code to the deployment of software applications. To alleviate the burden from the developer teams having to manage the lifecycle and enforce rules between various parts or steps of end-to-end software development, continuous integration (CI) and continuous delivery (CD) systems can be implemented to automate and streamline the software development lifecycle. CI/CD systems can involve and execute complex pipelines. A pipeline for an application can include parts or steps, such as, code testing, integration testing, building, build testing, updating, deploying, and monitoring the application. Different CI/CD systems may be tasked to execute a part of the pipeline for the application on a namespace for the developer team (e.g., a particular namespace that the developer team is allowed to access), and to manage the execution (e.g., monitor the progress of the part of the pipeline). An example of a CI/CD system is a deployment manager that can manage application definitions, configurations, environments, and version control. The deployment manager can streamline application deployment and monitor the deployment.

Often, CI/CD systems may need access and/or permissions to execute the part of the pipeline (e.g., one or more associated actions) on the namespace on behalf of the developer team. In some cases, the CI/CD systems may be given complete administrative access or all permissions to perform actions on the whole shared infrastructure. Such solutions can be problematic from a security standpoint because mistakes can impact the other namespaces that may belong to other developer teams that share the infrastructure. A CI/CD system could execute the part of the pipeline in a namespace that the developer team does not have access to.

A solution can be implemented to give the CI/CD systems limited permissions to execute the part of the pipeline. A developer team may begin by creating a project using a project manager. The project may have a project name. The project may have a plurality of environments (e.g., development environment, staging environment, production environment, etc.). In some cases, each environment may have multiple clusters for the environment (e.g., USWEST1, USCENTRAL1, USEAST1). For the project, the developer team may identify a source repository for the project. The developer team may request a namespace to be provisioned for the project, such as a namespace on a cluster grouping a set of resources that the developer team can manipulate for the particular project. Namespace and project may be synonymous or have a 1:1 relationship. The project manager may create the namespace on the cluster. The project manager may create the namespace on a number of clusters.

The project manager may request a deployment manager to create separate application definitions for each combination of a source repository, a project name, and an environment. The application definitions may have the deployer role associated with them. The deployment manager may create separate secrets that can be used by a deployment service to request action(s) to be performed for a particular application definition or make certain application programming interface (API) requests related to the particular application definition. Specifically, separate secrets may be created that allows a deployment service to make an API request to the deployment manager to execute an action in a part of a pipeline in repository X for cluster Y and namespace Z in environment A. In other words, the secrets can individually be scoped for executing an action in a part of a pipeline in repository X for cluster Y and namespace Z in environment A by the deployment service. The deployment service may make an API request, to the deployment manager, to deploy an application once the deployment service has determined that the application is ready to be deployed. To make the API request, the deployment service may fetch a specific secret that is scoped for the API request that would trigger the deployment manager to execute an action in a part of a pipeline in repository X for cluster Y and namespace Z in environment A. The separate secrets generated by the deployment manager may be provided to the namespace controller. The namespace controller may write the secrets to the secrets manager at paths that only the deployment service may access. Moreover, the paths are specified in the secrets manager to ensure that, at deploy time, the secret that is fetched from the secrets manager is the specific secret scoped to execute the action associated with the API request to deploy the application. The paths may be unique to different actions in a part of a pipeline in repository X for cluster Y and namespace Z in environment A. If an API request to deploy the application is called from a pipeline in repository X for cluster Y and namespace Z in environment A, then only the secret scoped to the combination X-Y-Z-A can be read from the path specific to the combination X-Y-Z-A from the secrets manager by the deployment service.

When it is time to deploy an application or perform an action as part of a pipeline specified in an application definition, the deployment service may retrieve a secret from the secrets manager that gives the deployment service authorization to request the deployment manager to deploy or synchronize the application. The deployment service may retrieve a secret from the secrets manager, which allows the deployment service to make an API request to the deployment manager to perform the action at the namespace. Fetching the appropriately scoped secret from the secrets manager, the deployment service can use the secret to make the API request to the deployment manager. In response to receiving the API request and authenticating the API request using the scoped secret provided by the deployment service, the deployment manager then executes the action a part of a pipeline in repository X for cluster Y and namespace Z in environment A corresponding to the API request.

In a separate workflow, the deployment manager may obtain or be provided with credentials to make changes to the namespace to perform an action in a part of a pipeline in repository X for cluster Y and namespace Z in environment A. In some embodiments, the deployment manager may be, by default, authorized to deploy to any namespace in any cluster. The deployment manager may have a service account with a cloud service provider to make changes to any clusters managed by the cloud service provider. Administrators can bypass using API tokens to take escalated actions if needed. However, non-administrative deployment actions, such as the ones taken by the deployment service, are to use the scoped secrets, e.g., API tokens, to deploy to clusters. In some embodiments, the deployment manager may be provided with credentials to deploy to specific namespaces (e.g., by the namespace controller).

Adhering to the principle of least privilege access, permission(s) for executing the part of the pipeline may be narrowly scoped for the CI/CD system executing the part of the pipeline for an application (e.g., deployment of an application to a namespace), so that the CI/CD system may have only what the system needs to execute the part of the pipeline, and no more. Authorization to make the API request to the CI/CD system application (e.g., the deployment manager) is narrowly scoped for the deployment service making the API requests with the CI/CD system. The secrets manager restricts access to the secrets by ensuring that the secrets are written to paths that only the party (e.g., the deployment service) requiring the secrets may access. In addition, the paths in the secrets manager adheres to the principle of least privilege access because the paths are specific to an action in a part of a pipeline in repository X for cluster Y and namespace Z in environment A. The deployment service making the API request to execute the action in a part of a pipeline in repository X for cluster Y and namespace Z in environment A would need to request a secret that is scoped to the combination X-Y-Z-A. The deployment service may obtain that specific secret by passing the specific parameters X, Y, Z, and A specifying the path to the secrets manager to fetch the secret. In other words, the deployment service is expected to obtain a secret one at a time, and can only obtain the appropriate specific secret when the deployment service specifies the combination X-Y-Z-A when making the API request to execute a specific action in a part of a pipeline in repository X for cluster Y and namespace Z in environment A.

The resulting system may have several layers of security measures. A namespace controller can enforce where an application can be deployed or what actions can be performed by the deployment manager. The deployment manager can enforce which services may make API calls by generating a secret for each application definition that can be used to make API calls to the deployment manager. Each application definition can be scoped for an action in a part of a pipeline in repository X for cluster Y and namespace Z in environment A. The secrets manager can securely maintain secrets and control who may or may not have access to the secrets. Moreover, the secrets manager can use specific paths to ensure that only a deployment service making an API request to a deployment manager to perform an action in a part of a pipeline in repository X for cluster Y and namespace Z in environment A can access the secret (e.g., the API token) scoped for the API request. Revocation and management of secrets can be done by the deployment manager and the secrets manager. Processes for generating and obtaining tokens in the resulting system can remove the human in the loop, which may lower chances of human errors.

### Exemplary AV Management System

To better understand the varied systems associated with AVs, FIG. 1 illustrates an exemplary AV management system 100 that may be used to facilitate AV operations, according to some aspects of the disclosed technology.

One of ordinary skill in the art will understand that, for the AV management system 100 and any system discussed in the present disclosure, there may be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 may communicate with one another over one or more networks. AV may be a part of a fleet of AVs managed by system 100.

AV 102 may navigate about roadways without a human driver based on sensor signals generated by multiple sensor systems 104, 106, and 108. The sensor systems 104-108 may include different types of sensors and may be arranged about the AV 102. For instance, the sensor systems 104-108 may comprise Inertial Measurement Units (IMUs), cameras (e.g., still image cameras, video cameras, etc.), light sensors (e.g., light detection and ranging (LIDAR) systems, ambient light sensors, infrared sensors, etc.), radio detection and ranging (RADAR) systems, a Global Navigation Satellite System (GNSS) receiver, (e.g., Global Positioning System (GPS) receivers), audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, sensor system 104 may be a camera system, the sensor system 106 may be a LIDAR system, and the sensor system 108 may be a RADAR system. Other embodiments may include any other number and type of sensors.

AV 102 may also include several mechanical systems that may be used to maneuver or operate AV 102. For instance, mechanical systems may include vehicle propulsion system 130, braking system 132, steering system 134, safety system 136, and cabin system 138, among other systems. Vehicle propulsion system 130 may include an electric motor, an internal combustion engine, or both. The braking system 132 may include an engine brake, a wheel braking system (e.g., a disc braking system that utilizes brake pads), hydraulics, actuators, and/or any other suitable componentry configured to assist in decelerating AV 102. The steering system 134 may include suitable componentry configured to control the direction of movement of the AV 102 during navigation. Safety system 136 may include lights and signal indicators, a parking brake, airbags, and so forth. The cabin system 138 may include cabin temperature control systems, in-cabin entertainment systems, and so forth. In some embodiments, the AV 102 may not include human driver actuators (e.g., steering wheel, handbrake, foot brake pedal, foot accelerator pedal, turn signal lever, window wipers, etc.) for controlling the AV 102. Instead, the cabin system 138 may include one or more client interfaces (e.g., GUIs, Voice User Interfaces (VUIs), etc.) for controlling certain aspects of the mechanical systems 130-138.

AV 102 may additionally include a local computing system 110 that is in communication with the sensor systems 104-108, the mechanical systems 130-138, the data center 150, and the client computing device 170, among other systems. The local computing system 110 may include one or more processors and memory, including instructions that may be executed by the one or more processors. The instructions may make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing system 110 includes a perception stack 112, a mapping and localization stack 114, a planning stack 116, a control stack 118, a communications stack 120, an HD geospatial database 122, and an AV operational database 124, other applications 192, among other stacks and systems. Collectively, a perception stack 112, a mapping and localization stack 114, a planning stack 116, a control stack 118 of the local computing system 110 may provide functionalities of an AV stack.

Perception stack 112 may enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 122, other components of the AV, and other data sources (e.g., the data center 150, the client computing device 170, third-party data sources, etc.). Perception stack 112 may detect and classify objects and determine their current and predicted locations, speeds, directions, and the like. In addition, perception stack 112 may determine the free space around the AV 102 (e.g., to maintain a safe distance from other objects, change lanes, park the AV, etc.). Perception stack 112 may also identify environmental uncertainties, such as where to look for moving objects, flag areas that may be obscured or blocked from view, and so forth.

Mapping and localization stack 114 may determine the AV's position and orientation (pose) using different methods from multiple systems (e.g., GPS, IMUs, cameras, LIDAR, RADAR, ultrasonic sensors, the HD geospatial database 122, etc.). For example, in some embodiments, the AV 102 may compare sensor data captured in real-time by the sensor systems 104-108 to data in the HD geospatial database 122 to determine its precise (e.g., accurate to the order of a few centimeters or less) position and orientation. The AV 102 may focus its search based on sensor data from one or more first sensor systems (e.g., GPS) by matching sensor data from one or more second sensor systems (e.g., LIDAR). If the mapping and localization information from one system is unavailable, the AV 102 may use mapping and localization information from a redundant system and/or from remote data sources.

Planning stack 116 may determine how to maneuver or operate the AV 102 safely and efficiently in its environment. For example, the planning stack 116 may receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., an Emergency Vehicle (EMV) blaring a siren, intersections, occluded areas, street closures for construction or street repairs, DPVs, etc.), traffic rules and other safety standards or practices for the road, user input, and other relevant data for directing the AV 102 from one point to another. The planning stack 116 may determine multiple sets of one or more mechanical operations that the AV 102 may perform (e.g., go straight at a specified speed or rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 116 may select from multiple backup plans to carry out. For example, while preparing to change lanes to turn right at an intersection, another vehicle may aggressively cut into the target lane, making the lane change unsafe. The planning stack 116 could have already determined an alternative plan for such an event, and upon its occurrence, help to direct the AV 102 to go around the block instead of blocking a current lane while waiting for an opening to change lanes.

Control stack 118 may manage the operation of the vehicle propulsion system 130, the braking system 132, the steering system 134, the safety system 136, and the cabin system 138. The control stack 118 may receive sensor signals from the sensor systems 104-108 as well as communicate with other stacks or components of the local computing system 110 or a remote system (e.g., the data center 150) to effectuate the operation of the AV 102. For example, control stack 118 may implement the final path or actions from the multiple paths or actions provided by the planning stack 116. The implementation may involve turning the routes and decisions (e.g., a trajectory) from the planning stack 116 into commands for the actuators that control the AV's steering, throttle, brake, and drive unit.

The communication stack 120 may transmit and receive signals between the various stacks and other components of the AV 102 and between the AV 102, the data center 150, the client computing device 170, and other remote systems. The communication stack 120 may enable the local computing system 110 to exchange information remotely over a network. The communication stack 120 may also facilitate local exchange of information, such as through a wired connection or a local wireless connection.

The HD geospatial database 122 may store HD maps and related data of the streets upon which the AV 102 travels. In some embodiments, the HD maps and related data may comprise multiple layers, such as an areas layer, a lanes and boundaries layer, an intersections layer, a traffic controls layer, and so forth. The areas layer may include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer may include geospatial information of road lanes (e.g., lane or road centerline, lane boundaries, type of lane boundaries, etc.) and related attributes (e.g., direction of travel, speed limit, lane type, etc.). The lanes and boundaries layer may also include 3D attributes related to lanes (e.g., slope, elevation, curvature, etc.). The intersections layer may include geospatial information of intersections (e.g., crosswalks, stop lines, turning lane centerlines, and/or boundaries, etc.) and related attributes (e.g., permissive, protected/permissive, or protected only left-turn lanes; permissive, protected/permissive, or protected only U-turn lanes; permissive or protected only right-turn lanes; etc.). The traffic controls layer may include geospatial information of traffic signal lights, traffic signs, and other road objects and related attributes.

The AV operational database 124 may store raw AV data generated by the sensor systems 104-108 and other components of the AV 102 and/or data received by the AV 102 from remote systems (e.g., the data center 150, the client computing device 170, etc.). In some embodiments, the raw AV data may include HD LIDAR point cloud data, image or video data, RADAR data, GPS data, and other sensor data that the data center 150 may use for creating or updating AV geospatial data.

Data center 150 may include cluster infrastructure 176, continuous integration 180, continuous delivery 182, and security 190. In some cases, the data center 150 may include a plurality of data center facilities (e.g., buildings) in different physical locations.

Data center 150 may physically house cluster infrastructure 176. Cluster infrastructure 176 may include hardware resources and software resources. Hardware resources can include computing/processing resources, data storage resources, network resources, etc. Examples of computing/processing resources may include machine-learning processors (e.g., machine-learning accelerators or neural processing units), central processing units (CPUs), graphics processing units (GPUs), quantum computers, etc. Examples of data storage resources may include disk storage devices, memory storage devices, database servers, etc. Network resources may include network appliances (e.g., switches, routers, etc.), network connections, interconnects, etc. Software resources may include firmware for the hardware resources, operating systems for the hardware resources, virtual machines running on the hardware resources, software that manage the hardware resources, etc. Cluster infrastructure 176 may include resources managed by one or more providers.

Continuous integration 180 may include software that can work with or may be implemented on cluster infrastructure 176 to automate the process of building, testing, and integrating code changes from various developers/developer teams into a single software project. Developers/developer teams may write software code and commit changes to a shared repository using a version control system of continuous integration 180. A build service of continuous integration 180 may monitor for changes made to the repository using webhook(s) and can trigger a build whenever new code changes are detected (e.g., in response to a version control system sending out a payload to the webhook(s) notifying the build service that changes occurred to the repository). The build service of continuous integration 180 may run unit tests, and checks for code quality, style, and security issues. If the build fails, the build service may notify the developers/developer team. If the build succeeds, the code may be integrated into the main branch of the repository.

Continuous delivery 182 may include software that can work with or may be implemented on cluster infrastructure 176 to automate the process of developing and delivering software, such as releasing new features and updates. When the build service of continuous integration 180 determines that the build is ready to be deployed, continuous delivery 182 may deploy the code to a staging environment where the code may be tested further and monitored. A developer team may apply one or more fixes to the code in the staging environment until the developer team is satisfied with the stability of the code. Once the team is satisfied with the stability of the code (e.g., if the code passes certain tests), continuous delivery 182 may deploy the code to a production environment. If the code fails or has issues in the production environment, the code may be rolled back (although a roll back is to be avoided if possible).

Security 190 may implement systems and security protocols to manage user/service/application authentication and authorization to secure and protect resources in the cluster infrastructure 176. For instance, security 190 may include identities (and roles) management (e.g., to maintain a database of users/services/applications that may have certain rights in the cluster infrastructure 176). Security 190 may include authorities that can verify identities and issue tokens or certificates for authenticated users/services/applications. The authorities may revoke tokens or certificates if appropriate. Security 190 may implement authorization protocols to verify whether authenticated users/services/applications have rights to perform certain actions. Authorization protocols can allow authenticated users/services/applications to perform authorized actions and disallow those users/services/applications to perform unauthorized actions. Security 190 may implement encryption and decryption of data. Security 190 may include one or more ingress controllers. An ingress controller can process incoming data traffic and disallow data traffic that does not have a token/certificate and only allow data traffic with a valid token to pass through the ingress controller. In some cases, an ingress controller may attach application-specific tokens to the data traffic based on the destination of the data traffic. Security 190 may include a secrets manager. A secrets manager may store secrets, which may include sensitive information. A secrets manager may keep the secrets secure by controlling who or which party may access the secrets. In some cases, the secrets manager may keep the secrets secure by requesting parties to provide specific parameters to access specific secrets stored at a particular path. Examples of secrets may include passwords, encryption keys, tokens, API tokens, certificates, configuration files, etc. A secrets manager may be accessed by authenticated and authorized parties only. Once authenticated, the parties may request access to secrets in accordance with security policies that may define how long the secrets may be accessed and by whom. The policies may be defined by specifying the paths to the secrets in the secrets manager and operations which may be allowed or denied by each party. Security 190 may include a namespace controller. A namespace controller may manage different namespaces that segment or isolate resources. Resources can include clusters in cluster infrastructure 176. Resources can include AVs such as AV 102. Namespaces can keep resources separate from each other. Roles can be assigned to a namespace so that only parties having those roles are allowed to manipulate the resources in the namespace. In other words, a namespace controller may implement role-based access control (RBAC) of namespaces. The roles assigned to a namespace may have permissions which are specified for the different roles. A role may be allowed to view the namespace only. Another role may be allowed to deploy applications in the namespace. Another role may be allowed to modify resources allocated to the namespace.

The data center 150 having cluster infrastructure 176 may be a private cloud (e.g., an enterprise network, a co-location provider network, etc.), a public cloud (e.g., an infrastructure as a service (IaaS) network, a platform as a service (PaaS) network, a software as a service (SaaS) network, or other communication service provider (CSP) network), a hybrid cloud, a multi-cloud, and so forth. The data center 150 may include cluster infrastructure 176, which can include hardware and software resources remote to the local computing system 110 for managing a fleet of AVs and AV-related services. For example, in addition to managing the AV 102, the data center 150 may also support a ridehailing/ridesharing service, a delivery service, a remote/roadside assistance service, street services (e.g., street mapping, street patrol, street cleaning, street metering, parking reservation, etc.), sensor calibration, and the like.

Cluster infrastructure 176 may include resources, such as clusters, nodes, pods deployed on nodes, etc. A cluster operator may define and provision resources in a cluster using a suitable infrastructure manager through machine-readable definition files. Applications (and services) can be deployed onto a cluster using application orchestration. Application orchestration can orchestrate deployment, maintenance, and scaling of applications on the resources in a cluster. Application orchestration can implement a control plane in the cluster that may service requests for application deployment and requests for maintaining applications running on the cluster. In some embodiments, a control plane may include persistent, lightweight, distributed key-value data store to store configuration data of the cluster, an application programming interface, a scheduler to assign unscheduled applications to a specific resource in the cluster, one or more controllers/operators each having a reconciliation loop, and a controller manager that manages the one or more controllers/operators. The control plane may orchestrate applications onto resources in the cluster, which may be organized and managed by the control plane using nodes and optionally node pools.

A cluster may have one or more nodes. A node may be a resource on which an application (e.g., systems, services, workloads, etc.) can be deployed. A node may include a virtual or physical machine. Virtual machines are machines that emulate physical machines and are implemented on physical hardware. A node has a corresponding configuration. The configuration may include properties such as a machine type, a resource type, a specific operating system image, a minimum computing platform, amount of allocable data and/or computing resources for the node (also referred to as a shape of a node), a specific network interface, maximum number of applications that can run on the node, etc. The health/status of the node may be managed by the control plane. A node pool may be a group of nodes within a cluster that all have the same configuration. A cluster may have one or more node pools.

A pod may be a unit that can be handled by the scheduler in the control plane. The control plane can schedule pods onto nodes in the cluster infrastructure. A pod may include an application (e.g., containerized application, a container, or a container application) that performs a function or provides a service. The scheduler may schedule pods to nodes or node pools based on the configurations and health/state of the nodes or node pools. The control plane may schedule and deploy one or more pods on a given node. An application can be deployed as a pod on a node in cluster infrastructure. A pod may have one or more resources provisioned for the pod, and/or one or more endpoints configured for the pod. For simplicity, nodes and node pools on which pods are deployed are not shown in the figures. In some cases, a pod may be configured to run a single application or container. In some cases, a pod may be configured to run multiple applications, or multiple containers.

Namespaces may segregate or isolate resources in a node. A namespace may have one or more pods and/or one or more other objects. Different namespaces may be assigned to different developer teams so that one developer team's work does not conflict with another developer team's work on the same node.

The data center 150 may send and receive various signals to and from the AV 102 and the client computing device 170. These signals may include sensor data captured by the sensor systems 104-108, roadside assistance requests, software updates, ridesharing pick-up and drop-off instructions, and so forth.

In this example, the data center 150 includes one or more of a data management platform 152, an Artificial Intelligence/Machine-Learning (AI/ML) platform 154, a simulation platform 156, a remote assistance platform 158, a ridehailing/ridesharing platform 160, and a map management platform 162, among other systems. Many of these systems can be implemented and supported by cluster infrastructure 176.

Data management platform 152 may be a “big data” system capable of receiving and transmitting data at high speeds (e.g., near real-time or real-time), processing a large variety of data, and storing large volumes of data (e.g., terabytes, petabytes, or more of data). The varieties of data may include data having different structures (e.g., structured, semi-structured, unstructured, etc.), data of different types (e.g., sensor data, mechanical system data, ridesharing service data, map data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 may access data stored by the data management platform 152 to provide their respective services.

The AI/ML platform 154 may provide the systems for training and evaluating machine-learning algorithms for operating the AV 102 (e.g., machine-learning models used in the AV stack), the simulation platform 156, the remote assistance platform 158, the ridehailing/ridesharing platform 160, the map management platform 162, and other platforms and systems. Using the AI/ML platform 154, data scientists may prepare data sets from the data management platform 152; select, design, and train machine-learning models; evaluate, refine, and deploy the models; maintain, monitor, and retrain the models; and so on.

The simulation platform 156 may simulate (or mimic) and/or augment real-world conditions (e.g., roads, lanes, buildings, obstacles, other traffic participants (e.g., other vehicles, cyclists, and pedestrians), trees, lighting conditions, weather conditions, etc.) so that the AV stack of an AV may be tested in a virtual environment that is similar to a real physical world. The simulation platform 156 may create a virtual environment that emulates physics of the real-world and sensors of an AV. Testing and evaluating AVs in simulation platform 156 can be more efficient and allow for creation of specific traffic scenarios that may occur rarely in the real-world. Moreover, the AV stack can even be tested in thousands of scenarios in parallel in simulation. More specifically, the AV stack may be executed in a simulator simulating various traffic scenarios at a time. With simulation platform 156, the AV stack implementing the perception, prediction, planning, and control algorithms can be developed, evaluated, validated, and fine-tuned in a simulation environment. The simulation platform 156 can also be used to evaluate only a portion of the AV stack.

The remote assistance platform 158 may generate and transmit instructions to control the operation of the AV 102. For example, in response to active trigger(s) being detected by the local computing system 110 on the AV 102, the remote assistance platform 158 may respond by creating a remote assistance session with a remote assistance operator to assist the AV 102. The remote assistance platform 158 may, with assistance from the remote assistance operator, generate and transmit instructions to the AV 102 to cause the AV 102 to perform a special driving maneuver (e.g., to drive AV 102 in reverse). The remote assistance platform 158 may utilize the remote assistance session to communicate with a customer in the AV 102 via the client computing device 170 to resolve concerns of the customer.

The ridehailing/ridesharing platform 160 (e.g., a web application) may interact with a customer of a ridehailing/ridesharing service via a ridehailing/ridesharing application 172 executing on the client computing device 170. Ridehailing/ridesharing platform 160 may provide delivery services as well. The client computing device 170 may be any type of computing system, including a server, desktop computer, laptop, tablet, smartphone, smart wearable device, gaming system, or other general-purpose computing device for accessing the ridehailing/ridesharing application 172. The client computing device 170 may be a customer's mobile computing device or a computing device integrated with the AV 102 (e.g., the local computing system 110). The ridehailing/ridesharing platform 160 may receive requests to be picked up or dropped off from the ridehailing/ridesharing application 172 and dispatch the AV 102 for the trip. A similar platform can be provided for delivery services.

Map management platform 162 may provide a set of tools for the manipulation and management of geographic and spatial (geospatial) and related attribute data. The data management platform 152 may receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data may be processed, and map management platform 162 may render base representations (e.g., tiles (2D), bounding volumes (3D), etc.) of the AV geospatial data to enable users to view, query, label, edit, and otherwise interact with the data. Map management platform 162 may manage workflows and tasks for operating on the AV geospatial data. Map management platform 162 may control access to the AV geospatial data, including granting or limiting access to the AV geospatial data based on user-based, role-based, group-based, task-based, and other attribute-based access control mechanisms. Map management platform 162 may provide version control for the AV geospatial data, such as to track specific changes that (human or machine) map editors have made to the data and to revert changes when necessary. Map management platform 162 may administer release management of the AV geospatial data, including distributing suitable iterations of the data to different users, computing devices, AVs, and other consumers of HD maps. Map management platform 162 may provide analytics regarding the AV geospatial data and related data, such as to generate insights relating to the throughput and quality of mapping tasks.

Data management platform 152, AI/ML platform 154, simulation platform 156, remote assistance platform 158, ridehailing/ridesharing platform 160, map management platform 162, applications/stacks on local computing system 110 may be developed and deployed by a number of developer teams. Lifecycles of the platforms and/or applications can be managed by continuous integration 180 and continuous delivery 182.

Exemplary CI/CD System with Secured Deployment of Applications

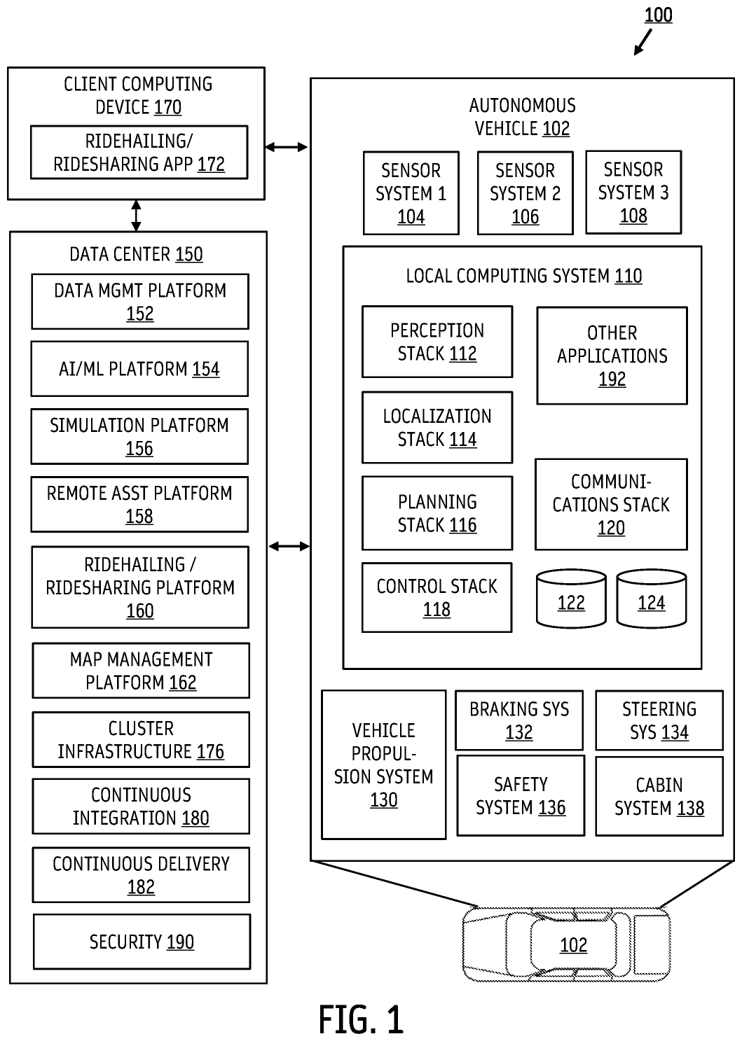

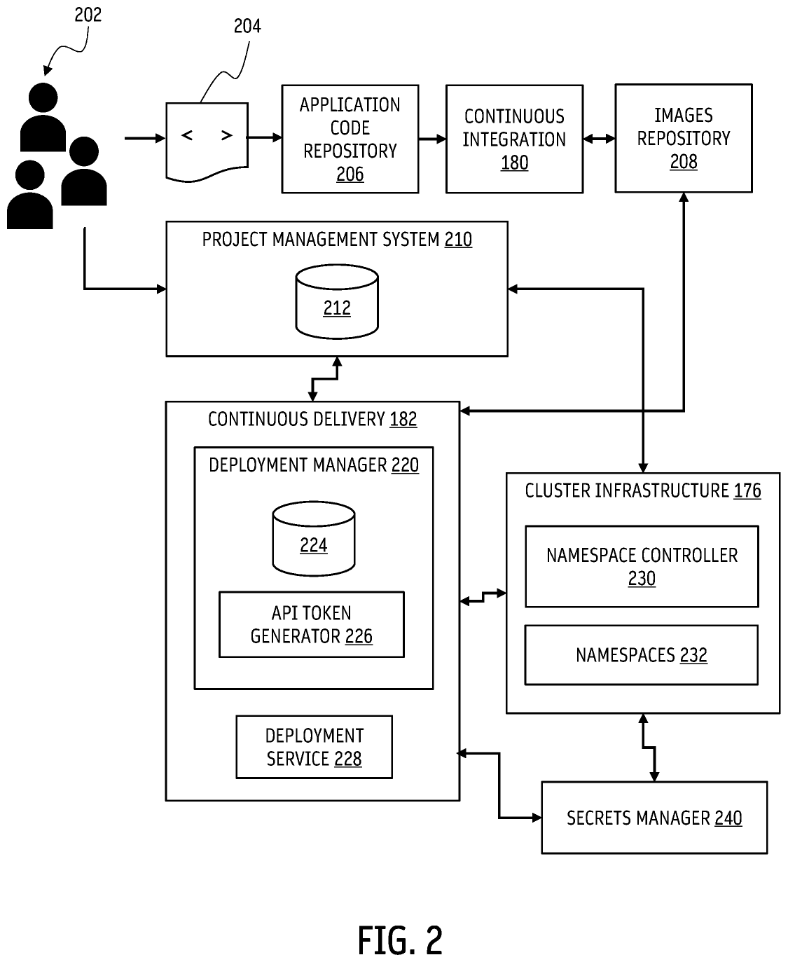

FIG. 2 illustrates an exemplary system that application developers may use to develop and deploy applications onto remote locations such as specific namespaces, according to some aspects of the disclosed technology.

Developer team 202 may create a project for managing the work to be done for one or more applications. Developer team 202 may submit a project definition to project management system 210. Project management system 210 may maintain various project definitions in project definition store 212 for different developer teams. Project management system 210 may help developer team 202 to plan, track, test, and document the project for the application. Project management system 210 may support developer workflows that include agile development, test case management, issue tracking, time planning, and documentation. The work to be done for one or more applications may be assisted or managed by continuous integration 180 and/or continuous delivery 182.

Developer team 202 may write code 204 and commit code 204 to application code repository 206. Continuous integration 180 may manage activities such as version control, code testing, and builds. Successful builds, e.g., images of applications that can be deployed/installed onto computing resources, may be stored and managed in images repository 208. Software build images may include files that have the compiled code and dependencies of an application. The images in images repository 208 can be deployed to different environments, such as development, testing, or production.

When a project is created by developer team 202, project management system 210 may organize resources on cluster infrastructure 176 for the project. Project management system 210 may notify continuous delivery 182 to assist or manage one or more continuous delivery activities for the project.

Continuous delivery 182 may have a deployment manager 220 that may coordinate or orchestrate one or more continuous delivery activities, such as deployment of applications, updating applications, monitoring applications, rolling back applications, etc. Deployment manager 220 may be authorized to make changes on namespaces 232 on cluster infrastructure 176. Deployment manager 220 may maintain application definitions for different applications being deployed. Application definitions may be maintained in application definition store 224. Deployment manager 220 may include API token generator 226, which can generate and/or issue tokens to be used by services to make authorized API calls to deployment manager 220. API calls can be made to specific application definitions in application definition store 224. Continuous delivery 182 may have a deployment service 228, which can make API calls to deployment manager 220. Deployment service 228 may use an API token to make an authenticated/authorized API call to deployment manager 220. Deployment service 228 may implement one or more services that may assist deployment manager 220 in deploying an application, e.g., onto cluster infrastructure 176. Deployment service 228 may obtain information or files that may assist deployment manager 220 in deploying an application, e.g., onto cluster infrastructure 176. Deployment service 228 may be triggered by a part of continuous delivery 182 and/or a part of continuous integration 180 to make an API call to deployment manager 220, e.g., when it is time to execute an action as part of a CD pipeline in repository X for cluster Y and namespace Z in environment A.

Cluster infrastructure 176 may include namespace controller 230. Namespace controller 230 may segregate resources in cluster infrastructure 176, e.g., clusters, nodes, pods, etc. Namespace controller 230 may create namespaces within compute systems of an AV fleet (not shown in FIG. 2). Namespace controller 230 may provision namespaces 232 to segregate resources in cluster infrastructure. In some cases, namespace controller 230 may provision namespaces to segregate resources within compute systems of an AV fleet. Namespace controller 230 may provision namespaces to divide resources into smaller containers that can have different settings and permissions.

Namespace controller 230 may provision namespaces to divide cluster infrastructure 176 into smaller units. Namespaces 232 in cluster infrastructure 176 can be used to isolate resources, such as pods, services, deployments, and secrets, from other namespaces, and to apply quotas and limits to them. Namespaces 232 in cluster infrastructure 176 can also be used to group related resources together, such as for developer team 202, a specific project created in project management system 210, or environment. A namespace in namespaces 232 can work by creating a logical boundary for a set of resources within a cluster. Each resource in a namespace has a unique name that distinguishes it from other resources in the same namespace. A namespace in namespaces 232 can also have its own configuration, such as labels, annotations, and network policies, that affect how the resources interact with each other and with the outside world. A namespace in namespaces 232 can also have its own service account and RBAC rules, that determine who can access and manage the resources in the namespace, and what the roles can do in the namespace. To create and use a namespace in cluster infrastructure 176, a command-line tool, API, and/or a configuration file can be used to define the properties of a namespace, such as its name, labels, and annotations. Applying a configuration file using a command-line tool or an API can configure the namespace onto cluster infrastructure 176. A namespace in namespaces 232 may correspond to a project definition submitted by a developer team, e.g., developer team 202.

Secrets manager 240 may secure sensitive information, such as API tokens generated by API token generator 226.

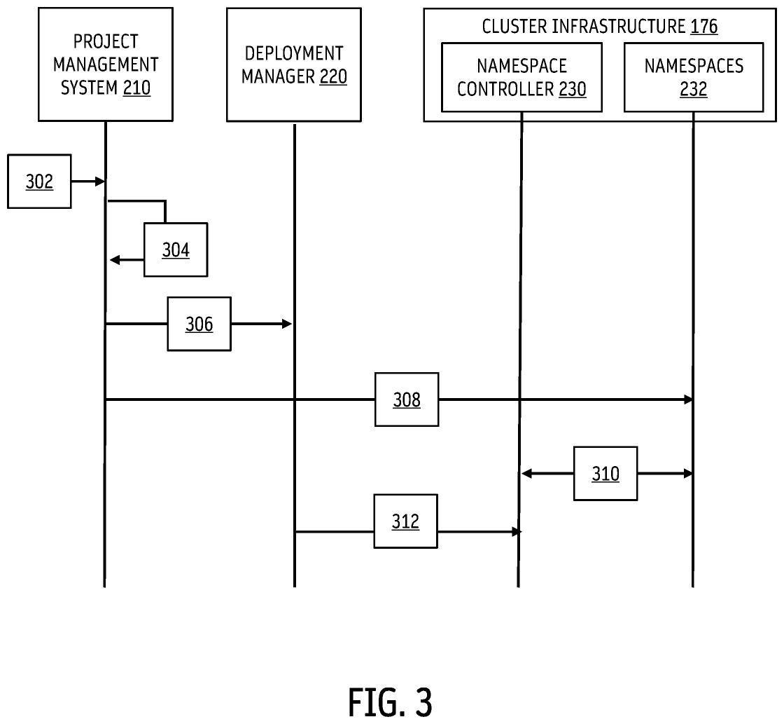

FIGS. 3-6 are exemplary sequence diagrams that illustrate processes that may be performed by the components illustrated in FIG. 2.

FIG. 3 illustrates an exemplary sequence diagram illustrating creation of projects and namespaces, according to some aspects of the disclosed technology.

In 302, project management system 210 may receive a project definition of a project from a developer. The project definition may have the project name (e.g., “my-project”). The project name may be unique. A developer may, in the project definition, specify a namespace to be created for the project. The namespace may include resources that are dedicated and isolated for the project. The project definition may specify one or more source repository (e.g., “my-repo”). Source code and/or software images may be maintained in the source repository. The project definition may have one or more applications, and the one or more applications may be managed in the source repository.

The project definition may specify one or more environments. The project definition may specify a pipeline of actions to be performed in the one or more environments. For deployment on cluster infrastructure, an application for the project may be rolled out in stages, e.g., to different environments. Examples of environments may include, e.g., development environment (“dev”), staging environment (“stg”), production environment (“prd”), production research & development environment (“prod-rnd”), production baking environment (“prod-bake”), production stable environment (“prod-stable”), etc. In some cases, each environment may have multiple clusters for the environment (e.g., USWEST1, USWEST2, USCENTRAL1, USCENTRAL2, USEAST1, USEAST2, etc.). For deployment onto compute systems of A Vs, the application for the project may be rolled out in stages, e.g., to different environments. Each environment may have different groups of compute systems of AVs (e.g., fully driverless AVs, with driver AVs, mapping AVs, research and development AVs, production AVs, ridehail/rideshare AVs, delivery AVs, AVs in region1, AVs in region2, model1 AVs, model2 AVs, etc.)

An example project definition may include:

Project Name: my-project
Namespace: my-project
Source repositories: {my-repo1, my-repo2}
Environments: {dev, stg, prod-rnd, prod-bake,
prod-stable}

In 304, project management system 210 may determine or identify separate deployment projects that correspond to the actions in the pipeline of deployment actions to be performed in the environments/channels. Separate deployment projects (for different actions in the pipeline of deployment actions) may be created for different combinations of repository X, cluster Y, namespace Z, and environment A. In some cases, a deployment project may correspond to a unique combination of: a source repository, a project name (or namespace), and an environment. A deployment project may have a name having a combination of: <source repository>, <project name>, <environment>. In some cases, a deployment project may correspond to a unique combination of: a source repository, a cluster, a namespace, and an environment. Examples of deployment projects may include:

Deployment Project 1: my-repo1-my-project-dev
Deployment Project 2: my-repo2-my-project-dev
Deployment Project 3: my-repo1-my-project-stg
Deployment Project 4: my-repo2-my-project-stg
Deployment Project 5: my-repo1-my-project-prod-rnd
Deployment Project 6: my-repo2-my-project-prod-rnd
Deployment Project 7: my-repo1-my-project-prod-bake
Deployment Project 8: my-repo2-my-project-prod-bake
Deployment Project 9: my-repo1-my-project-prod-stable
Deployment Project 10: my-repo2-my-project-prod-stable

In 306, project management system 210 may trigger the deployment projects to be created in deployment manager 220, and cause deployment manager 220 to create or store application definitions corresponding to the deployment projects. Project management system 210 may transmit to the deployment manager 220 a request to create an application definition for the project having the project name. Deployment manager 220 may receive information specifying details for the application definition from the project management system (e.g., a file or text that specifies the details for the application definition). Project management system 210 may request separate application definitions to be created for the deployment projects. Deployment manager 220 may store application definitions for each unique combination of: a source repository, a project name (or namespace), and an environment. For the example above, ten (10) separate application definitions may be created in deployment manager 220. In some cases, deployment manager 220 may store application definitions for each unique combination of: a source repository, a cluster, a namespace, and an environment.

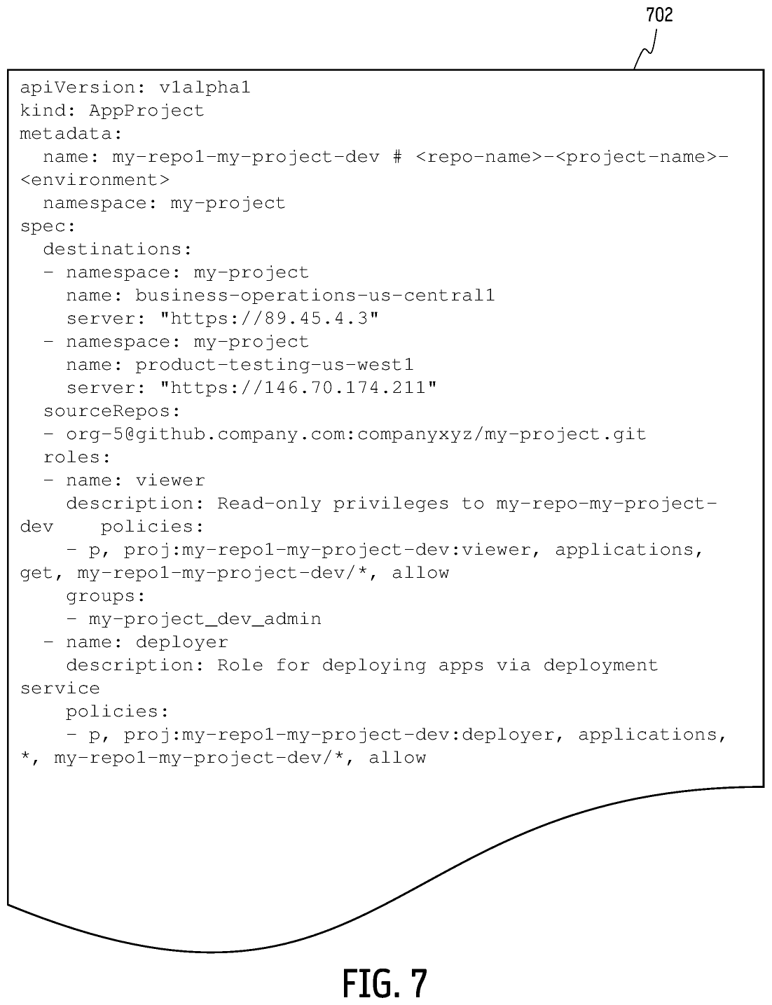

An application definition may have a unique name having a source repository, a project name (or namespace), and an environment. An exemplary application definition is shown in FIG. 7. In some embodiments, an application definition may have a unique name having a source repository, a cluster, a namespace, and an environment. Deployment manager 220 may receive, determine, and/or store an application definition for an application. An exemplary application definition may include one or more of: (1) an application definition name, (2) a project name, (3) a source repository (or one or more source repositories), (4) a destination (or one or more destinations), (5) an environment, (6) a role (or one or more roles), and (7) a policy associated with the role (or one or more policies associated with each role). In some cases, the project name is optional. In some cases, the environment is optional. In some cases, the role is optional. In some cases, the policy is optional.

An exemplary application may include one or more destinations. A destination may specify a namespace corresponding to the project. A destination may specify an environment corresponding to the deployment project and application definition. A destination may specify a destination name that uniquely identifies the destination. The destination name may include a name of a particular resource in the namespace, such as a particular cluster. A destination may specify a uniform resource locator (URL) or suitable location or path for the resource. In the case of deploying an application, a destination may correspond to a resource to which an application is to be deployed. A destination may correspond to a namespace provisioned on one or more clusters.

An application definition may correspond to the deployment project determined/identified in 304. The application definition may specify an application name that also corresponds to the deployment project determined/identified in 304. For example, an application definition may have “my-repo1-my-project-dev” as the application definition name, which corresponds to the deployment project having the same project name. The application definition name may be unique to the source repository, the project name, and the environment of the deployment project.

Depending on the deployment project, one or more roles may be specified in the application definition. Roles may correspond to different levels of access (or sets of policies) in an RBAC system. Roles may include, e.g., viewer, deployer, administrator, developer, health monitor, etc. Project management system 210 may have information about roles and policies suitable for a given deployment project and requests the roles and policies to be defined in the application definition. Parties, such as users, services, systems, may be assigned to role(s). Including roles and policies associated with roles in an application definition allows the roles for each deployment project to be clearly defined, declared, specified, and scoped for each deployment project.

In the case of deploying an application, the application definition may specify a viewer role, and a policy associated with the viewer role. The viewer role may have a policy that specifies read-only privileges at a destination (e.g., within the namespace). The application definition may specify a deployer role, and a policy associated with the deployer role. The deployer role may have a policy that specifies privilege(s) or permission(s) to perform one or more actions at a destination (e.g., within the namespace). An action may include installing or deploying an application within a namespace from a source repository. The policy may be time limited. The policy may be conditioned on one or more conditions.

In 308, project management system 210 may trigger a namespace in a project definition to be created, as part of namespaces 232 in cluster infrastructure 176.

In 310, namespace controller 230 may monitor for changes in namespaces 232, such as a creation of a new namespace, deletion of a new namespace, merging of namespaces, etc. Namespace controller 230 may determine that a namespace, e.g., “my-proj”, was created in namespaces 232 for a project having the project name. Creation of a namespace in namespaces 232 may alert namespace controller 230 to ensure that appropriate credentials (e.g., secrets, tokens, configuration files) for accessing the created namespace may need to be provisioned.

In 312, deployment manager 220 may notify namespace controller 230 of one or more application definitions that were created. Deployment manager 220 may indicate to namespace controller 230 that role having an associated policy may require permissions to manipulate the namespace.

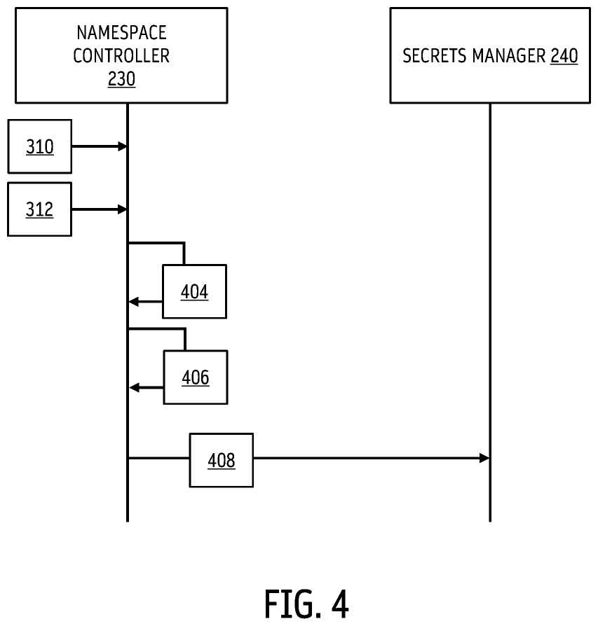

FIG. 4 illustrates an exemplary sequence diagram illustrating generation of API tokens, according to some aspects of the disclosed technology.

In 310, changes in namespaces 232 may trigger namespace controller 230 to configure namespaces, e.g., begin provisioning credentials for the namespace and any roles that may need to manipulate the namespace.

In some cases, namespace controller 230 may be triggered by the lack of credentials provisioned for a namespace. Namespace controller 230 may query a secrets manager to determine if there are already credentials provisioned for the namespace.

In some cases, namespace controller 230 may be triggered by deployment manager 220 notifying namespace controller 230 that one or more application definitions have been created in 312.

In some cases, namespace controller 230 may be triggered by the lack of credentials provisioned for an application definition. Namespace controller 230 may query a secrets manager to determine if there are already credentials provisioned for the application definition. Namespace controller 230 may verify that only one secret is provisioned for a particular application definition.

In 404, namespace controller 230 may add a role specified in the application definition (e.g., a deployer role) to the namespace. Namespace controller 230 may add the associated policy of the role specified in the application definition to the namespace. Namespace controller 230 may configure a namespace corresponding to a project having the project name to permit the role specified in the application definition to perform an action at the namespace in accordance with the policy. A deployment manager may use the role to perform the action at the namespace in accordance with the policy.

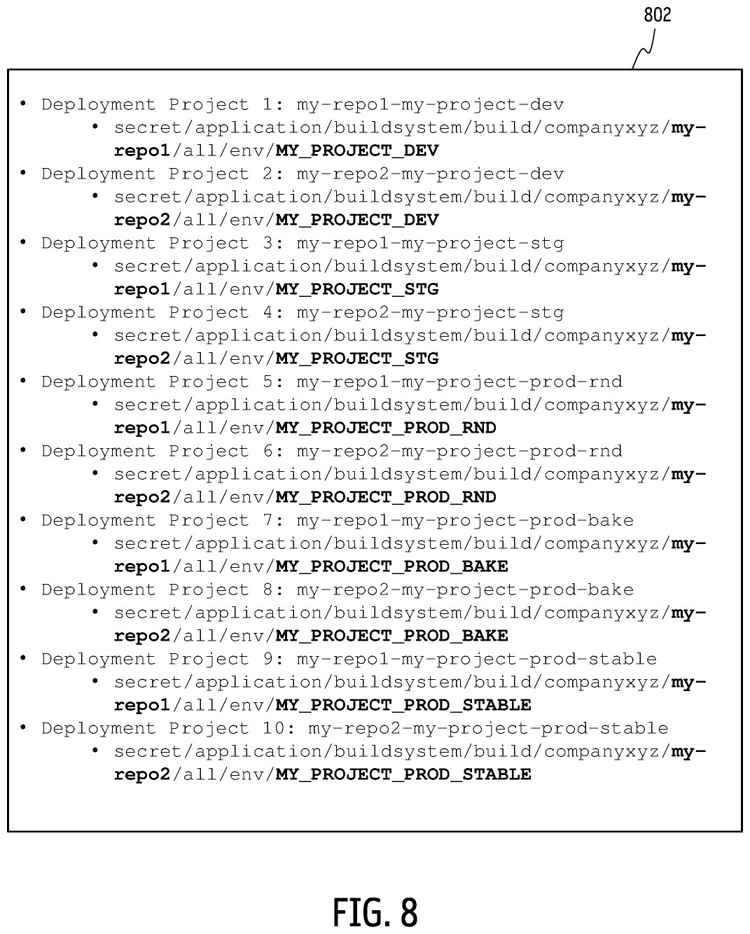

In 406, namespace controller 230, looking to limit permissions and access on a per application definition (e.g., per deployment action, per repository X for cluster Y and namespace Z in environment A) basis, may determine a path that is unique to the application definition. The path is used to uniquely store credentials for the role to perform an action (corresponding to the combination of repository X, cluster Y, namespace Z, and environment A) in accordance with the policy within the namespace. The path may be a path provisioned in secrets manager 240. The path may be unique to the project name, the source repository, and the environment. In some cases, the path may be unique to the source repository, the destination cluster, the namespace or project name, and the environment. The secrets manager 240 may restrict access to sensitive information stored at the path, to a deployment service (e.g., deployment service 228) that may trigger actions to be formed with the application definition. More specifically, secrets manager 240 may restrict access to sensitive information stored at the path to a deployment service (e.g., deployment service 228) that is able to produce the parameters that specify the exact path (e.g., the parameters may include repository X, cluster Y, namespace Z, and environment A). Exemplary paths are illustrated in FIG. 8. Different paths may be determined for different application definitions (e.g., different deployment applications).

In 408, namespace controller 230, may store sensitive information and/or secrets in the determined path in the secrets manager 240. Namespace controller 230 may cause secrets manager 240 to write the sensitive information and/or the secrets in the specified/determined path for the application definition.

In some cases, the secrets manager 240 restricts namespace controller 230 to only be able to read and write to the specific paths, such as the path mentioned in 406 and 408. In some cases, the secrets manager 240 restricts namespace controller 230 to only be able to write to the specific paths. In some cases, the secrets manager 240 restricts namespace controller 230 to be able to write and read to the specific paths. The ability to read and write at the specific paths can enable namespace controller 230 to enable namespace controller 230 to self-heal. Due to the decentralized nature of namespace controller 230 (e.g., namespace controller 230 does not control creation of application definitions), namespace controller 230 may on occasion need to delete tokens if more than one token exists, or if tokens exist in deployment manager (e.g., deployment manager 220) but not in secrets manager 240. The latter could occur if a token was generated by deployment manager 220 but an error inhibited that token from being written to the secrets manager 240. On every loop of the namespace controller 230, namespace controller 230 may verify only one token exists for each application definition and that token is written to the secrets manager 240 at the appropriate path.

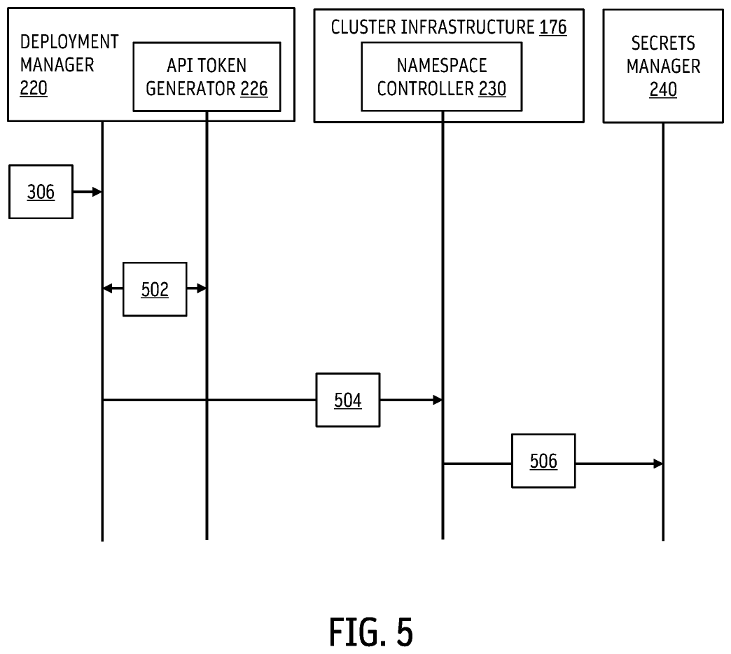

FIG. 5 illustrates an exemplary sequence diagram illustrating generation of application programming interface (API) tokens, according to some aspects of the disclosed technology;

In 306, deployment manager 220 may be triggered by receipt or creation of application definitions corresponding to different deployment projects, e.g., to create separate credentials for the application definitions. Credentials for the application definitions for deployment manager 220 may include API tokens that may be used for authenticating/authorizing API calls being made to different application definitions. Separate credentials may be provisioned for different application definitions, thereby restricting and scoping permissions on a per application definition (e.g., per deployment action, or per repository X for cluster Y and namespace Z in environment A) basis.

In 502, deployment manager 220 may request API token generator 226 to generate an API token for the application definition. API token generator 226 may generate a secret, e.g., an API token, for each application definition. API token generator 226 of deployment manager 220 may generate a secret (e.g., an API token) specific to the application definition. A separate secret may be generated for each application definition. A secret may be unique to each combination of: a source repository, a project name (or namespace), and an environment. The secret may allow a deployment service (e.g., deployment service 228) to be authenticated/authorized to request the deployment manager 220 to synchronize the application corresponding to the application definition. The API token can be used by the deployment manager 220 to enforce which entity may be allowed to make API calls for the application definition. The API token can be used by the deployment manager 220 to make sure that only the entity trying to make an API request to kick off a part of a pipeline in repository X for cluster Y and namespace Z in environment A is able to get the API token to make the API request.

In 504, deployment manager 220 may transmit the secret to a namespace controller 230. Deployment manager 220 may specify that the secret corresponds to the application definition.

In 506, namespace controller 230 may store the secret in a path in secrets manager 240. The path may be the same path in 406 and 408 of FIG. 4. Secrets manager 240 may restrict access to the secret to an entity, e.g., the deployment service 228, that may make an API call to trigger a deployment to be performed by deployment manager 220. Namespace controller 230 may configure secrets manager 240 to ensure that the entity, e.g., the deployment service 228, can access specific secrets stored in paths which are unique to different application definitions. Using the paths, secrets manager 240 can ensure that only the entity that is trying to make an API call for a specific application definition can access the secret(s) to be used for making the API call for the specific application definition.

The paths (discussed in 406, 408, and 506) that the deployment service 228 is able to access can be restricted by the secrets manager 240 and managed by the secrets manager 240 itself, driven by configuration in each repository. Namespace controller 230 can be given access to a subset of these paths in addition to the deployment service (e.g., deployment service 228), to allow namespace controller 230 to put these secrets in paths where the secrets can already be consumed by the deployment service (e.g., deployment service 228) in 506.

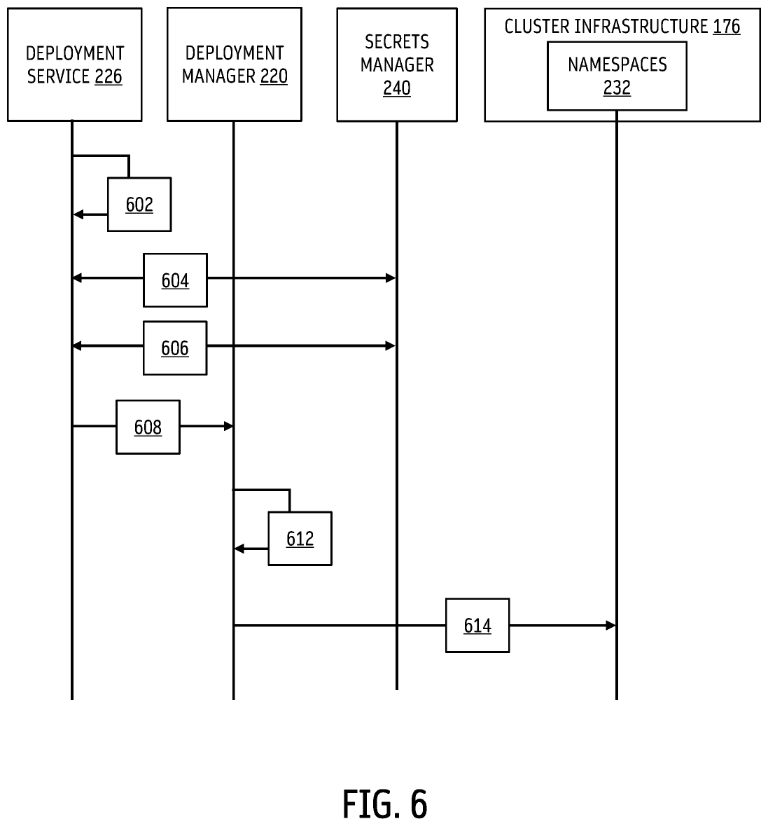

FIG. 6 illustrates an exemplary sequence diagram illustrating deployment of an application, according to some aspects of the disclosed technology. Deployment service 228 may execute different pipelines depending on which environment an application is being deployed. Each environment's pipeline can be granted access to various secrets (e.g., API tokens) for performing different actions in the pipeline for the given environment. For example, production pipelines may have additional restrictions, ensuring controlled and authorized executions.

In 602, a deployment service 228 (e.g., part of continuous delivery 182) may determine that an application is ready to be deployed for a project from a source repository in an environment. Deployment service 228 may determine that an action of a part of a pipeline in repository X for cluster Y and namespace Z in environment A is ready to be performed by the deployment manager 220. Deployment service 228 may determine that the deployment action is ready for a particular deployment project, which may have a corresponding application definition in deployment manager.

In 604, deployment service 228 may retrieve the secret from 502 of FIG. 5 stored at the path from secrets manager 240. Deployment service 228 may use specific parameters for that application definition corresponding to the action in the pipeline that deployment service 228 is looking to trigger to retrieve the secret from 502 at the path. In some embodiments, secrets manager 240 may provide the secret from 502 to deployment service 228 only if deployment service 228 is able to specify the path, e.g., using parameters that specify the combination corresponding to the action in the pipeline: repository X, cluster Y, namespace Z, and environment A.

In 606, deployment service 228 may retrieve the credential from 408 of FIG. 4 stored at the path from secrets manager 240.

In 608, deployment service 228 may use the secret to get authenticated/authorized to make an API call or request to the application definition (e.g., to sync the application associated with the application definition, to deploy the application associated with the application definition, to monitor the application associated with the application definition, etc.). In 608, deployment service 228 may transmit, to deployment manager, a request to deploy the application at the destination, using the source repository and the secret retrieved in 604. Deployment manager 220 may receive the request and the secret. The destination and the source repository may be specified in the application definition.

In 612, deployment manager 220 may authenticate/authorize the request in 608 using the secret.

In 614, deployment manager 220 may, in response to 612, assume the deployer role, which was specified in the application definition. Deployment manager 220 assuming the deployer role may deploy the application at the destination using the source repository.

### Exemplary Application Definition and Exemplary Paths for Storing API Tokens for Different Application Definitions

FIG. 7 illustrates an exemplary application definition 702, according to some aspects of the disclosed technology. Application definition 702 may include an application definition name:

my-repo1-my-project-dev

Application definition 702 may include a project name, or a namespace:

my-project

Application definition 702 may include one or more source repositories:

org-5@github.company.com:companyxyz/my-project.git

Application definition 702 may include one or more destinations:

```
destinations:
  - namespace: my-project
    name: business-operations-us-central1
    server: “https://89.45.4.3.”
  - namespace: my-project
    name: product-testing-us-west1
    server: “https://146.70.174.211”
```

A destination may include a namespace, a destination name, and a path or location of the destination (e.g., URL to the server).

Application definition 702 may include one or more roles and one or more policies corresponding to the roles:

```
roles:
  - name: viewer
    description: Read-only privileges to my-repo-my-
  project-dev
    policies:
    - p, proj:my-repo1-my-project-dev:viewer, applications,
  get, my-repo1-my-project-dev/*, allow
  - name: deployer
    description: Role for deploying apps via deployment
  service
    policies:
  - p, proj:my-repo1-my-project-dev:deployer,
  applications, *, my-repo1-my-project-dev/*, allow
```

The one or more roles may include a viewer role and a deployer role. A role may have a name, e.g., viewer, deployer, etc. A role may have a description that describes the level of access the role may have to the destination. A policy for a role may include a permission to perform one or more actions at a destination (e.g., namespace) using the source repository. The action may include deploying an application from the source repository onto the destination (e.g., namespace).

FIG. 8 illustrates exemplary paths 802 for storing different API tokens, according to some aspects of the disclosed technology. API tokens may be generated for different application definitions and may be stored in separate paths in a secrets manager. The paths may include a unique combination of the source repository, the project name, and the environment. The paths may include a unique combination of the source repository, destination/cluster, the project name/namespace, and the environment. The paths for storing sensitive information for exemplary deployment projects 1-10 are depicted in FIG. 8. The secrets manager may restrict which entity may retrieve the sensitive information stored in the paths using the paths. Specifically, the secrets manager may restrict access to the sensitive information stored in the paths to entities which can provide parameters that specify the paths. The entity may be a deployment service that is expected to trigger deployment actions to be performed for continuous delivery (e.g., a deployment service that is expected to make an API call to a deployment manager to trigger a deployment action for a pipeline from repository X, onto cluster Y, in namespace Z, and in environment A). One or more secrets may be stored at a path to ensure only authenticated and authorized entities are able to obtain sensitive information for individual deployment actions of a continuous delivery pipeline.

### Exemplary Computer-Implemented Methods for Managing Security in Application Deployment

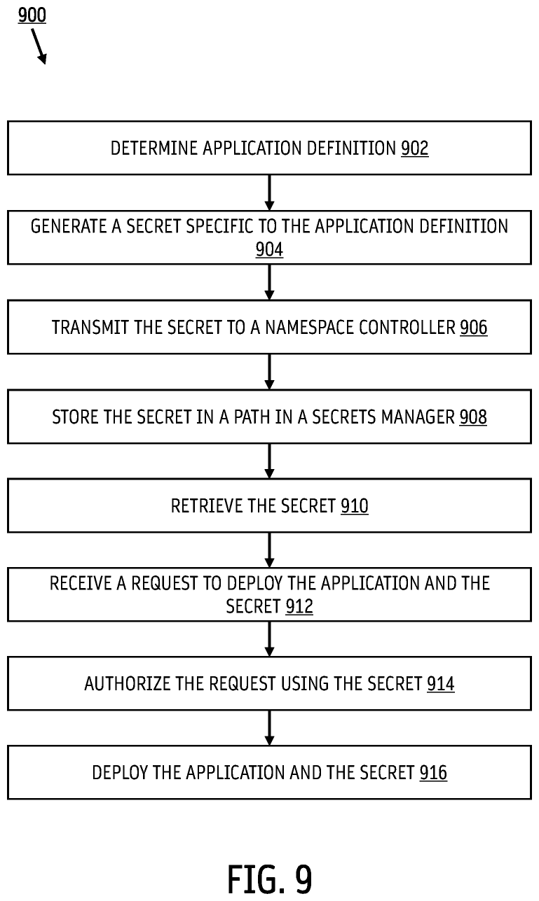

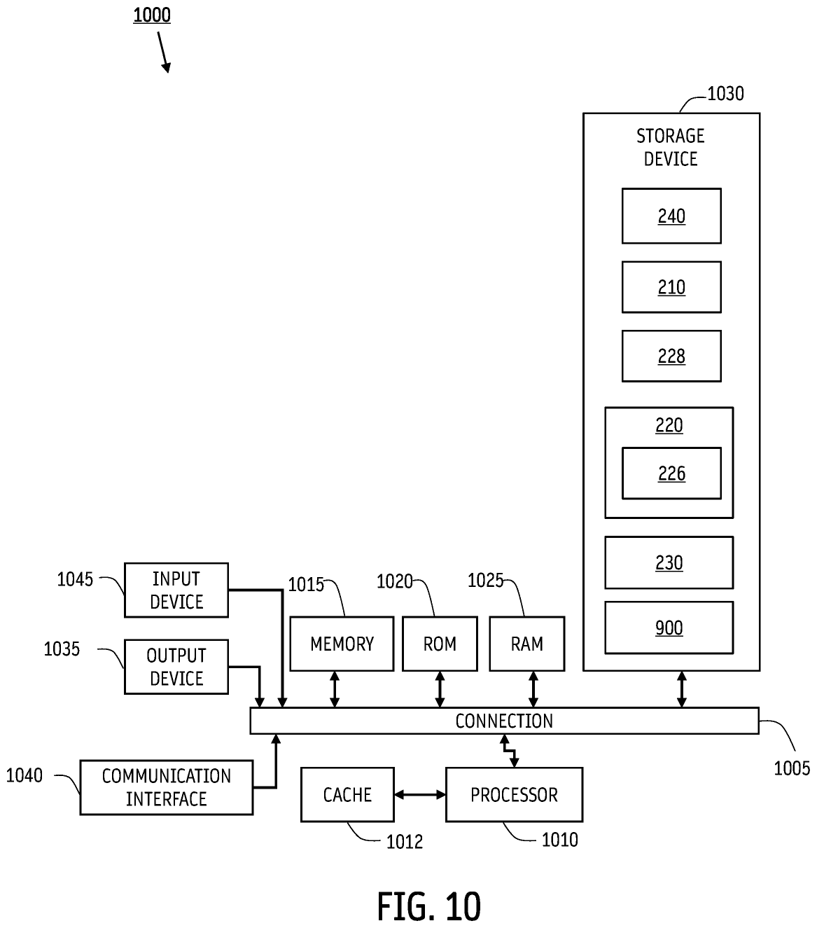

FIG. 9 is a flow diagram illustrating an exemplary computer-implemented method 900 for managing security in application deployment, according to some aspects of the disclosed technology. Various components illustrated in FIGS. 1-6 may carry out the computer-implemented method 900. The computer-implemented method 900 may be encoded as instructions and provided in storage device 1030 of FIG. 10.

In 902, a deployment manager may determine an application definition for an application. The application definition may include one or more of: (1) an application definition name, (2) a project name, (3) a source repository, (4) a destination, (5) an environment, (6) a role, and (7) a policy associated with the role.

In 904, the deployment manager may generate a secret specific to the application definition, e.g., a unique combination of the source repository, the project name, and the environment.

In 906, the deployment manager may transmit the secret to a namespace controller.

In 908, the namespace controller may store the secret in a path in a secrets manager.

In 910, a deployment service may retrieve the secret from the secrets manager at the path.

In 912, the deployment manager may receive, from the deployment service, a request to deploy the application at the destination using the source repository, and the secret.

In 914, the deployment manager may authorize the request using the secret.

In 916, the deployment manager, assuming the role, may deploy the application at the destination using the source repository.

### Exemplary Processor-Based System

FIG. 10 illustrates an exemplary processor-based system with which some aspects of the subject technology may be implemented. For example, processor-based system 1000 may be any computing device making up, or any component thereof in which the components of the system are in communication with each other using connection 1005. Connection 1005 may be a physical connection via a bus, or a direct connection into processor 1010, such as in a chipset architecture. Connection 1005 may also be a virtual connection, networked connection, or logical connection.

In some embodiments, computing system 1000 represents the local computing system 100 of FIG. 1 and/or the parts of cluster infrastructure 176 in data center 150 of FIG. 1. In some embodiments, one or more of the described system components represents many such components each performing some or all of the function for which the component is described. In some embodiments, the components may be physical or virtual devices.

Exemplary system 1000 includes at least one processor 1010 (e.g., a CPU or another suitable processing unit) and connection 1005 that couples various system components including system memory 1015, such as Read-Only Memory (ROM) 1020 and Random-Access Memory (RAM) 1025 to processor 1010. Computing system 1000 may include a cache of high-speed memory 1012 connected directly with, in close proximity to, or integrated as part of processor 1010.

Processor 1010 may include any general-purpose processor and a hardware service or software service, such as executable instructions that implement functionalities such as methods and processes described herein. Processor 1010 may be a completely self-contained computing system, containing multiple cores or processors, a bus, memory controller, cache, etc. A multi-core processor may be symmetric or asymmetric.

To enable user interaction, computing system 1000 includes an input device 1045, which may represent any number of input mechanisms, such as a microphone for speech, a touch-sensitive screen for gesture or graphical input, keyboard, mouse, motion input, speech, etc. Computing system 1000 may also include output device 1035, which may be one or more of a number of output mechanisms known to those of skill in the art. In some instances, multimodal systems may enable a user to provide multiple types of input/output to communicate with computing system 1000. Computing system 1000 may include communications interface 1040, which may generally govern and manage the user input and system output. The communication interface may perform or facilitate receipt and/or transmission of wired or wireless communications via wired and/or wireless transceivers.

Storage device 1030 may be a non-volatile and/or non-transitory and/or computer-readable memory device and may be a hard disk or other types of computer-readable media which may store data that are accessible by a computer.

Storage device 1030 may include software services, servers, services, etc. When the code that defines such software is executed by processor 1010, the software may cause the system 1000 to perform a function. In some embodiments, a hardware service that performs a particular function may include the software component stored in a computer-readable medium in connection with the necessary hardware components, such as processor 1010, connection 1005, output device 1035, etc., to carry out the function.

One or more components illustrated in FIGS. 2-6 may be encoded in instructions stored in storage device 1030. The instructions may be executable by the at least one processor 1010 to carry out the functionalities of the one or more components. Examples of components may include project management system 210, deployment manager 220, API token generator 226, deployment service 228, namespace controller 230, and secrets manager 240.

Data in one or more stores illustrated in FIG. 2 may be stored in storage device 1030.

### Select Examples

Example 1 provides a computer-implemented method for managing security in application deployment, including determining, by a deployment manager, an application definition for an application, the application definition having (one or more of, two or more of, three or more of, four or more of, five or more of, or six or more of): (1) an application definition name, (2) a project name, (3) a source repository, (4) a destination, (5) an environment, (6) a role, and (7) a policy associated with the role; generating, by the deployment manager, a secret specific to the application definition; transmitting, by the deployment manager, the secret to a namespace controller; storing, by the namespace controller, the secret in a path in a secrets manager; retrieving, by a deployment service, the secret from the secrets manager at the path; receiving, by the deployment manager from the deployment service, a request to deploy the application at the destination using the source repository, and the secret; authorizing, by the deployment manager, the request using the secret; and deploying, by the deployment manager assuming the role, the application at the destination using the source repository.

Example 2 provides the computer-implemented method of example 1, further including determining, by the namespace controller, that a namespace is created for a project having the project name.

Example 3 provides the computer-implemented method of example 1 or 2, further including configuring, by the namespace controller, a namespace corresponding to a project having the project name to permit the role to perform an action at the namespace in accordance with the policy.

Example 4 provides the computer-implemented method of any one of examples 1-3, where the path is unique to the source repository, the project name, and the environment.

Example 5 provides the computer-implemented method of any one of examples 1-4, where the secret allows the deployment service to be authorized to request the deployment manager to synchronize the application.

Example 6 provides the computer-implemented method of any one of examples 1-5, further including receiving, by the deployment manager from a project manager, a request to create the application definition for a project having the project name.

Example 7 provides the computer-implemented method of any one of examples 1-6, where the application definition name is unique to the source repository, the project name, and the environment.

Example 8 provides a computer-implemented system for deploying applications onto cluster infrastructure, including a deployment manager to: determine an application definition for an application, the application definition having (one or more of, two or more of, three or more of, four or more of, five or more of, or six or more of): (1) an application definition name, (2) a project name, (3) a source repository, (4) a destination, (5) an environment, (6) a role, and (7) a policy associated with the role; generate a secret specific to the application definition; and transmit the secret to a namespace controller; a namespace controller to: store the secret in a path in a secrets manager; and a deployment service to: retrieve the secret from the secrets manager at the path; and transmit, to a deployment manager, a request to deploy the application the application at the destination using the source repository, and the secret.

Example 9 provides the computer-implemented system of example 8, further including the deployment manager to: authorize the request using the secret; and deploy, assuming the role, the application at the destination using the source repository.

Example 10 provides the computer-implemented system of example 8 or 9, where the namespace controller is further to: determine, that a namespace is created for a project having the project name.

Example 11 provides the computer-implemented system of any one of example 8-10, where the namespace controller is further to: configure a namespace corresponding to a project having the project name to permit the role to perform an action at the namespace in accordance with the policy.

Example 12 provides the computer-implemented system of any one of examples 8-11, where the path is unique to the source repository, the project name, and the environment.

Example 13 provides the computer-implemented system of any one of examples 8-12, where the secret allows the deployment service to be authorized to request the deployment manager to synchronize the application.

Example 14 provides the computer-implemented system of any one of examples 8-13, where the deployment manager is further to: receive, from a project manager, a request to create the application definition for a project having the project name.

Example 15 provides the computer-implemented system of any one of examples 8-14, where the application definition name is unique to the source repository, the project name, and the environment.

Example 16 provides one or more non-transitory computer-readable media storing instructions that, when executed by one or more processors, cause the one or more processors to: determine an application definition for an application, the application definition having (one or more of, two or more of, three or more of, four or more of, five or more of, or six or more of): (1) an application definition name, (2) a project name, (3) a source repository, (4) a destination, (5) an environment, (6) a role, and (7) a policy associated with the role; generate a secret specific to the application definition; transmit the secret to a namespace controller, where the secret allows a deployment service to be authorized to request a deployment manager to synchronize the application; and store the secret in a path in a secrets manager, where the path has parameters including the source repository, the project name, the destination, and the environment, and the path is accessible by the deployment service that is able to specify the parameters.

Example 17 provides the one or more non-transitory computer-readable media of example 16, where the instructions, when executed by the one or more processors, cause the one or more processors to further: retrieve the secret from the secrets manager at the path using the parameters; receive, from the deployment service, a request to deploy the application at the destination using the source repository, and the secret; authenticate and authorize the request using the secret; and deploy the application at the destination using the source repository by assuming the role.

Example 18 provides the one or more non-transitory computer-readable media of example 16 or 17, where the instructions, when executed by the one or more processors, cause the one or more processors to further: determine a namespace is created for a project having the project name.

Example 19 provides the one or more non-transitory computer-readable media of any one of examples 16-18, where the instructions, when executed by the one or more processors, cause the one or more processors to further: configure a namespace corresponding to a project having the project name to permit the role to perform an action at the namespace in accordance with the policy.

Example 20 provides the one or more non-transitory computer-readable media of any one of examples 16-19, where the instructions, when executed by the one or more processors, cause the one or more processors to further: receive from a project manager, a request to create the application definition for a project having the project name.

Example 21 provides the one or more non-transitory computer-readable media of any one of examples 16-20, where the application definition name is unique to the source repository, the project name, and the environment.

Example 22 is an apparatus comprising means to carry out or means for carrying out any one of the computer-implemented methods of examples 1-7.

### VARIATIONS AND OTHER NOTES

Although the various operations shown in and described with reference to FIGS. 3-6 and 9 are illustrated as occurring once each and in a particular order, it will be recognized that the operations may be performed in any suitable order and repeated as desired. Additionally, one or more operations may be performed in parallel. Furthermore, the operations illustrated in FIGS. 3-6 and 9 may be combined or may include more or fewer details than described.

Cluster infrastructure 176 may include clusters having virtual machines running on the clusters (e.g., in cloud service provider infrastructure and/or in on-premise data center infrastructure). In some cases, cluster infrastructure 176 may include compute systems of AVs having virtual machines running on the compute systems of AVs. In some cases, local computing systems or compute systems on AVs can be a special case of a type of cluster infrastructure 176. Compute systems on AVs can be managed in a similar fashion as cluster infrastructure 176. Applications/software can be deployed onto the compute systems in a similar fashion as deploying applications/software onto clusters in cluster infrastructure 176. In some cases, certain services that run on the AV compute systems can be segregated into their own namespaces such that only the developer team that owns that service is allowed to change the namespace. The described techniques for securing deployment actions can be extended to non-cloud use cases (beyond deployment onto clusters in cluster infrastructure 176) such as the deployment of applications/software on the AV compute systems.

Embodiments within the scope of the present disclosure may also include tangible and/or non-transitory computer-readable storage media or devices for carrying or having computer-executable instructions or data structures stored thereon. Such tangible computer-readable storage devices may be any available device that may be accessed by a general-purpose or special-purpose computer, including the functional design of any special-purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

The detailed description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

What is claimed is:

1. A computer-implemented method for managing security in application deployment, comprising:
determining, by a deployment manager, an application definition for an application, the application definition having: (1) an application definition name, (2) a project name, (3) a source repository, (4) a destination, (5) an environment, (6) a role, and (7) a policy associated with the role;
generating, by the deployment manager, a secret specific to the application definition;
transmitting, by the deployment manager, the secret to a namespace controller;
storing, by the namespace controller, the secret in a path in a secrets manager;
retrieving, by a deployment service, the secret from the secrets manager at the path;
receiving, by the deployment manager from the deployment service, a request to deploy the application at the destination using the source repository, and the secret;
authorizing, by the deployment manager, the request using the secret; and
deploying, by the deployment manager assuming the role, the application at the destination using the source repository.

2. The computer-implemented method of claim 1, further comprising:
determining, by the namespace controller, that a namespace is created for a project having the project name.

3. The computer-implemented method of claim 1, further comprising:
configuring, by the namespace controller, a namespace corresponding to a project having the project name to permit the role to perform an action at the namespace in accordance with the policy.

4. The computer-implemented method of claim 1, wherein the path is unique to the source repository, the project name, and the environment.

5. The computer-implemented method of claim 1, wherein the secret allows the deployment service to be authorized to request the deployment manager to synchronize the application.

6. The computer-implemented method of claim 1, further comprising:
receiving, by the deployment manager from a project manager, a request to create the application definition for a project having the project name.

7. The computer-implemented method of claim 1, wherein the application definition name is unique to the source repository, the project name, and the environment.

8. A computer-implemented system for deploying applications onto cluster infrastructure, comprising:
a deployment manager to:
determine an application definition for an application, the application definition having three or more of: (1) an application definition name, (2) a project name, (3) a source repository, (4) a destination, (5) an environment, (6) a role, and (7) a policy associated with the role;
generate a secret specific to the application definition; and
transmit the secret to a namespace controller;
a namespace controller to:
store the secret in a path in a secrets manager; and
a deployment service to:
retrieve the secret from the secrets manager at the path; and
transmit, to a deployment manager, a request to deploy the application the application at the destination using the source repository, and the secret.

9. The computer-implemented system of claim 8, further comprising:
the deployment manager to:
authorize the request using the secret; and
deploy, assuming the role, the application at the destination using the source repository.

10. The computer-implemented system of claim 8, wherein the namespace controller is further to:
determine, that a namespace is created for a project having the project name.

11. The computer-implemented system of claim 8, wherein the namespace controller is further to:
configure a namespace corresponding to a project having the project name to permit the role to perform an action at the namespace in accordance with the policy.

12. The computer-implemented system of claim 8, wherein the path is unique to the source repository, the project name, and the environment.

13. The computer-implemented system of claim 8, wherein the secret allows the deployment service to be authorized to request the deployment manager to synchronize the application.

14. The computer-implemented system of claim 8, wherein the deployment manager is further to:
receive, from a project manager, a request to create the application definition for a project having the project name.

15. The computer-implemented system of claim 8, wherein the application definition name is unique to the source repository, the project name, and the environment.

16. One or more non-transitory computer-readable media storing instructions that, when executed by one or more processors, cause the one or more processors to:
determine an application definition for an application, the application definition having: (1) an application definition name, (2) a project name, (3) a source repository, (4) a destination, (5) an environment, (6) a role, and (7) a policy associated with the role;
generate a secret specific to the application definition;
transmit the secret to a namespace controller, wherein the secret allows a deployment service to be authorized to request a deployment manager to synchronize the application; and
store the secret in a path in a secrets manager, wherein the path has parameters comprising: the source repository, the project name, the destination, and the environment, and the path is accessible by the deployment service that is able to specify the parameters.

17. The one or more non-transitory computer-readable media of claim 16, wherein the instructions, when executed by the one or more processors, cause the one or more processors to further:
retrieve the secret from the secrets manager at the path using the parameters;
receive, from the deployment service, a request to deploy the application at the destination using the source repository, and the secret;
authenticate and authorize the request using the secret; and
deploy the application at the destination using the source repository by assuming the role.

18. The one or more non-transitory computer-readable media of claim 16, wherein the instructions, when executed by the one or more processors, cause the one or more processors to further:
determine a namespace is created for a project having the project name.

19. The one or more non-transitory computer-readable media of claim 16, wherein the instructions, when executed by the one or more processors, cause the one or more processors to further:
configure a namespace corresponding to a project having the project name to permit the role to perform an action at the namespace in accordance with the policy.

20. The one or more non-transitory computer-readable media of claim 16, wherein the instructions, when executed by the one or more processors, cause the one or more processors to further:
receive from a project manager, a request to create the application definition for a project having the project name.
